(19) United States
(12) Patent Application Publication
(10) Pub. No.: US 2015/0258845 A1
(43) Pub. Date: Sep. 17, 2015

(54) DECORATIVE PANEL

(71) Applicant: AKZENTA PANEELE + PROFILE GMBH, Kaisersesch (DE)

(72) Inventor: Hans-Jürgen Hannig, Bergisch-Gladbach (DE)

(21) Appl. No.: 14/425,793

(22) PCT Filed: Sep. 13, 2013
(86) PCT No.: PCT/EP2013/069031

§ 371 Date: Mar. 4, 2015

(30) Foreign Application Priority Data
Sep. 17, 2012 (EP) 12184669.5

(51) Int. Cl. B44F 9/00; E04F 15/10; E04F 19/00; B44F 5/00; E04F 13/07

(52) U.S. Cl. CPC B44F 9/00; B44F 5/00; E04F 13/07; E04F 19/00; E04F 15/10

(57) ABSTRACT

A decorative panel including a printed side edge and a method for producing such a panel. The decorative panel comprises a plate-shaped carrier and a decorative layer applied onto said carrier, wherein the carrier comprises a profile at least in an edge region, characterized in that the decorative layer is also applied in the region of the profile.

### REFERENCE TO RELATED APPLICATIONS

This application is a U.S. national stage application of International Patent Application No. PCT/EP2013/069031, filed Sep. 13, 2013, and claims the benefit of priority of European Application No. 12184669.5, filed Sep. 17, 2012, the entire disclosures of which are incorporated herein by reference.

### FIELD OF THE INVENTION

The present invention relates to a decorative panel including a side edge and a method for producing such a panel.

### BACKGROUND OF THE INVENTION

The term decorative panel in the sense of the invention means wall, ceiling or floor panels comprising a decor applied onto a carrier plate. Here, decorative panels are used in a variety of ways both in the field of interior design of rooms and for decorative cladding of buildings, for example in exhibition stand construction. One of the most common uses of decorative panels is their use as a floor covering. Herein, the decorative panels often comprise a decoration intended to replicate a natural material.

Examples of such replicated natural materials are wood species such as maple, oak, birch, cherry, ash, walnut, chestnut, wenge or even exotic woods such as Panga Panga, mahogany, bamboo and bubinga. In addition, often natural materials such as stone surfaces or ceramic surfaces are replicated.

Heretofore, such decorative panels have often been produced as laminates in which a decorative paper pre-printed with a desired decor is applied onto a carrier plate and, in turn, a so-called overlay is applied onto the decorative paper. After optionally a backing paper has been applied to the side of the carrier plate opposite to the decorative paper, the laminate structure obtained is fixedly bonded together by use of appropriate pressure and/or heat-activated adhesives.

Several of these panels may be connected to each other, for example, by tongue and groove connections provided in the edge regions. Herein, it may be provided that besides the corresponding tongue and groove profiles chamfers are provided which form joints between the interconnected panels. Herein, such joints serve decorative purposes, such as the replication of wide planks (V-joints). The chamfers provided for this purpose usually have an angle of inclination between 30° and 60°.

Because the corresponding profiling of the individual panels is carried out after the pressing of the laminate, for example, the chamfer edges form regions in which the decoration has been removed and the carrier material is visible even after assembly of the panels. Thus, however, although these regions are very small the decoration in these regions no longer corresponds to the desired replication of, for example, a natural material.

### SUMMARY OF THE INVENTION

Regarding this it is an object of the present invention to provide a decorative panel, which is able to overcome said disadvantage. Moreover, it is an object of the present invention to provide a method for producing such a decorative panel.

This object is achieved by a decorative panel comprising a plate-shaped carrier and a decorative layer ap-plied onto the carrier, wherein the carrier has a profile at least in an edge region, characterized in that the decorative layer is applied even in the region of the profile. Embodiments of this panel can be found in the dependent claims and in the following description.

### BRIEF DESCRIPTION OF THE DRAWINGS

FIG. 1 shows a cross sectional view of a profiled decorative panel according to the invention;

FIG. 2 shows a cross sectional view of a profile to be produced according to the invention in a carrier provided as a large plate; and

FIG. 3 shows a further configuration of a cross section of a profile to be produced according to the invention in a carrier provided as a large plate.

### DETAILED DESCRIPTION OF PREFERRED EMBODIMENTS

Thus, a decorative panel is proposed, which comprises a plate-shaped carrier and a decorative layer applied onto the carrier, wherein the carrier comprises a profile at least in an edge region, characterized in that the decorative layer is applied in the region of the profile, too. Herein, it can be provided that the decor replicates a natural material.

The plate-shaped carrier of the decorative panel is preferably formed of a material selected from the group consisting of wood, wood-based material, fiber material, plastic, glass, stone, ceramic, mineral material or mixtures thereof.

Wood-based materials in the sense of the invention in addition to solid wood materials are materials such as cross-laminated timber, glue-laminated timber, blockboard, veneered plywood, laminated veneer lumber, parallel strand lumber and bending plywood. In addition, wood-based materials in the sense of the invention are also chipboards such as pressboards, extruded boards, oriented structural boards (OSB) and laminated strand lumber as well as wood fiber materials such as wood fiber insulation boards (HFD), medium hard and hard fiberboards (MB, HFH) and in particular medium density fiberboards (MDF) and high density fiberboards (HDF). Even modern wood-based materials such as wood polymer materials (wood plastic composite, WPC), sandwich boards made of a lightweight core material such as foam, rigid foam or honeycomb paper and a layer of wood applied thereto, and minerally hardened, for example with cement, chipboards are wood-based materials in the sense of the invention. Moreover, cork represents a wood-based material in the sense of the invention.

In the sense of the invention the term fiber materials means materials such as paper and non-woven fabrics on the basis of plant, animal, mineral or even synthetic fibers as well as cardboards. Examples of fiber materials on the basis of plant fibers in addition to papers and non-woven fabrics made of cellulose fibers are boards made of biomass such as straw, maize straw, bamboo, leaves, algae extracts, hemp, cotton or oil palm fibers. Examples of animal fibers are keratin-based materials such as wool or horsehair. Examples of mineral fiber materials are mineral wool or glass wool.

Plastic materials which can be used as a carrier material are, for example, thermoplastics such as polyvinyl chloride, polyolefines (such as polyethylene (PE), polypropylene (PP)), polyamides (PA), polyurethanes (PU), polystyrene (PS), acrylonitril butadiene styrene (ABS), polymethyl methacrylate (PMMA), polycarbonate (PC), polyethylene terephthalate (PET), polyether ether ketone (PEEK) or mixtures or copolymerizates thereof. The plastic materials can include common fillers, such as calcium carbonate (chalk), aluminum oxide, silicagel, quartz powder, wood flour, gypsum. In addition they can be coloured in a known way. In particular it can be provided that the carrier material comprises a flame inhibitor.

In the sense of the invention the term stone and ceramic materials means materials such as granite, marble, sandstone, slate, tile, porcelain stoneware tiles and the like. Mineral materials in the sense of invention are, for example, plasterboard, cement or concrete slabs or mixed material sheets made of synthetic resin and mineral additives.

According to a preferred embodiment of the invention the decor is applied onto the carrier plate by means of a printing technique, preferably direct printing. Here, in the sense of the invention the term “direct printing” also means applying a decor by means of printing techniques onto a printable layer previously applied onto the carrier. Such a printable layer may be formed, for example, by a liquidly applied and subsequently cured primer layer or by a previously applied printable film, paper or nonwoven fabric layer. Herein, the primer layer can, for example, be formed from a curable and printable polymer composition, such as polyacrylate, polypropylene, polyethylene, polyurethane acrylate or the like which is applied as an appropriate pre-polymer composition onto the carrier plate and cured thereon by suitable means such as electromagnetic radiation or heat in order to obtain a corresponding layer. A suitable printable film layer may, for example, consist of a plastic material such as polyacrylate, polypropylene, polyethylene, polyurethane acrylate or the like, which can be applied onto the profiled carrier. Suitable papers are those that are also used as starting material for pre-printed decorative papers. Suitable nonwoven fabric layers are e.g. those based on plant, animal, mineral or synthetic fibers.

Onto the plate-shaped carrier profiled at least in an edge region or the printable layer applied thereon a desired decor can be applied by means of suitable printing techniques. Examples of suitable printing techniques for direct printing of decorative panels are letterpress printing processes such as flexographic printing, offset printing or gravure printing, or screen printing processes such as silk-screen printing. Herein, it can in particular be provided that the decor is applied by digital printing processes, such as an inkjet process.

According to a further embodiment of the invention it may be provided that the decorative panel comprises a wearing and/or top layer on top of the decorative layer. A wearing and/or top layer in the sense of the invention is a layer applied as an outer finishing layer, which in particular protects the decorative layer from wear or damage caused by dirt, moisture or mechanical impacts such as abrasion. Herein, it may be provided that the wearing layer includes hard materials such as titanium nitride, titanium carbide, silicon nitride, silicon carbide, boron carbide, tungsten carbide, tantalum carbide, alumina (corundum), zirconia or mixtures thereof in order to increase the wear resistance of the layer. The wearing and/or top layer may be applied, for example, as a liquid composition onto the carrier printed with the decor and cured thereon. Herein, it may be provided that the hard material is included in the wearing layer composition in an amount of between 5 wt.-% and 40 wt.-%, preferably between 15 wt.-% and 25 wt.-%. Preferably, the hard material has a mean grain diameter between 10 μm and 250 μm, more preferably between 10 μm and 100 μm. In this way it is advantageously achieved that the wearing layer composition forms a stable dispersion and a decomposition or precipitation of the hard material in the wearing layer composition can be avoided. For forming a corresponding wearing layer in one embodiment of the invention it is provided that the radiation curable composition including the hard material is applied at a concentration between 10 g/m² and 250 g/m², preferably between 25 g/m² and 100 g/m². In this case, the application can be implemented, for example, by means of rollers such as rubber rollers, or by means of pouring devices. According to a further embodiment of the invention it can be provided that the hard material is not included within the composition at the time of application of the wearing layer composition, but is scattered in the form of particles onto the applied wearing layer composition and subsequently the wearing layer is cured. Likewise, it may be provided that the wearing and/or top layer is laid onto the printed carrier as a prefabricated overlay layer and bonded thereto by means of pressure and/or heat.

According to a further embodiment of the invention it can be provided that the wearing and/or top layer comprises a surface texture substantially matching with the decor of the decorative layer. A surface texture matching with the decorative layer means that the surface of the decorative panel has a haptically perceptual structure, which according to its shape and pattern corresponds to the applied decor in order to achieve a reproduction of a natural material as close to the original as possible even with respect to the haptic. Herein, it can be provided that the carrier plate already comprises a texture and an alignment of a printing tool for applying the decor with respect to the carrier plate is implemented depending on the texture of the carrier plate which is detected by means of, for example, optical methods. Herein, for aligning the printing tool and the carrier plate relative to each other it can be provided that a relative movement between the printing tool and the carrier plate necessary for the alignment is implemented by shifting the carrier plate or by shifting the printing tool. According to a further embodiment of the invention it is provided that a texturing of the decorative panel is implemented subsequently to the application of the wearing and/or top layer. To this end it may be preferred to apply a settable composition as the wearing and/or top layer and a curing process is done solely to the extent that only a partial curing of the wearing and/or top layer is achieved. In the thus partially cured layer by means of appropriate tools, such as a hard metal texture roller or a die, a desired surface texture is embossed. Herein, the embossing process is implemented corresponding to the applied decor. In order to ensure a sufficient correspondence of the texture to be produced with the decor it may be provided that the carrier plate and the embossing tool are aligned relative to each other by corresponding relative movements. Subsequently to the production of the desired texture within the partially cured layer a further curing step is implemented with respect to the now textured wearing and/or top layer.

Regarding the method the object of the invention is achieved by a method for producing a decorative panel, including the steps of providing a plate-shaped carrier, at least partially profiling the plate-shaped carrier, and applying a decorative layer onto the at least partially profiled carrier.

Thus, a method for producing a decorative panel is proposed, comprising the steps of:

providing a plate-shaped carrier;

at least partial profiling the plate-shaped carrier;

applying a decorative layer onto the at least partially profiled carrier.

By applying the decor according to the invention after the at least partial of the carrier an abrasion or damage of the decor in the course of the profiling process is advantageously avoided.

By partial profiling the decorative panel not all profiles to be provided in the finished panel are produced, but only part of the profiles, while other profiles are produced in a subsequent step. Thus, it may be provided, for example, that the decorative profile to be provided in a panel, such as a chamfer, is produced in one step, while the functional profile, e.g. tongue and groove, is produced in a subsequent step.

Herein, the application of the decorative layer onto the at least partially profiled carrier may, for example, be implemented by means of an already pre-printed paper, which is applied onto the profiled partial portion of the carrier, too. In a particularly preferred embodiment of the method, however, it is provided that the decorative layer is applied onto the carrier by means of direct printing. Here, in the sense of the invention direct printing also means the application of the decor by means of printing techniques onto a printable layer previously applied to the carrier. Such a printable layer may be formed, for example, by a liquidly applied and subsequently cured primer layer or a previously applied printable film, paper or nonwoven fabric layer. On the plate-shaped carrier profiled at least in an edge region or on the printable layer applied thereon, the desired decor is applied by means of suitable printing techniques. Examples of suitable printing techniques for direct printing of decorative panels are letterpress printing processes, such as flexography, offset printing, gravure printing or screen printing processes such as silk-screen printing. In particular, it may be provided that the decor is applied by digital printing processes, such as inkjet processes.

Herein, it may be particularly provided that the master used for the printing process is distortion corrected in the region of the profile of the panel. Distortion correction in the sense of the invention means that the distortion of the printed image caused by the deviation of the profiling out of the surface plane of the carrier, for example, at a chamfer edge, is corrected by matching the master with the deviation. Herein, it may be provided, for example, that the correction of the distortion is implemented by matching the pixel spacing, the pixel size and/or the paint application depending on the intended edge profile of the finished decorative panel. In case of digital printing the print head can be driven depending on the distortion to be corrected, such that the print head, for example, is deflected beyond the profiled region and an the ink discharge is adapted to the profile.

A preferred embodiment of the method according to the invention comprises the additional step of applying a wearing and/or top layer subsequently to the application of the decorative layer. Here, the wearing and/or top layer may be applied in the manner described above as a prefabricated overlay or in liquid form onto the printed carrier and subsequently cured.

A further embodiment of the method comprises the additional step of producing a texture within the wearing and/or top layer substantially matching with the decor of the decorative layer. Herein, the texture may be produced in the manner already described above with respect to the corresponding panel.

According to a further particular preferred embodiment of the invention it may be provided that the plate-shaped carrier is provided as a large plate, which in a subsequent step is cut into a plurality of decorative panels. A large plate in the sense of the invention is a carrier whose dimensions exceed the dimensions of the final decorative panels multiple times and which in the course of the manufacturing process is cut into a corresponding plurality of decorative panels, for example by punching, sawing, laser or water jet cutting.

Here, it is e.g. possible that prior to the application of the decorative layer of the carrier provided as a large plate carrier, the joints (such as V-joints) to be provided in the final panel laminate, are milled into the carrier, on the thus profiled carrier at least the decorative layer is applied and subsequently the carrier is cut at least in the profiled areas. Herein, depending on the cutting method, such as sawing, laser or water jet cutting, it may be preferred that the required bleed allowance is taken into account in the produced profile.

According to a further embodiment of the method it is provided that an additional profiling step is implemented at least in a partial region of the edges of the decorative panel substantially in parallel to the surface of the panel. This allows, for example, the formation of the functional profiles, such as tongue and groove, within the panel. In the case of the provision of the carrier as a large plate such an additional profiling step is preferably carried out after cutting into individual panels. If the carrier is already provided in the desired size of the individual panel, such an additional profiling step may also be implemented simultaneously with the formation of the other profiles, such as a chamfer.

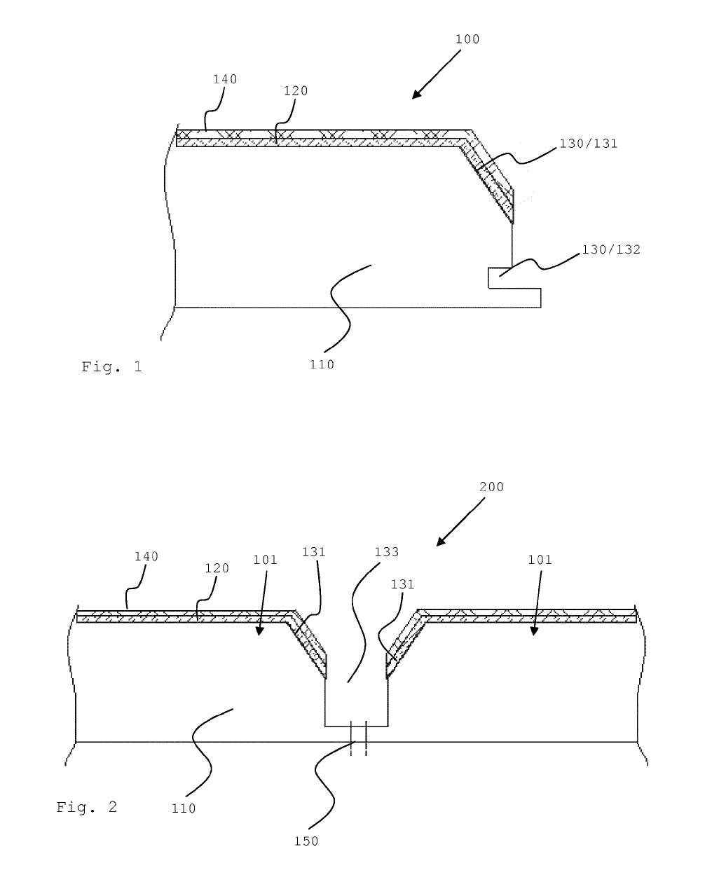

FIG. 1 shows a cross section of a decorative panel 100 profiled according to the invention. The decorative panel 100 comprises a plate-shaped carrier 110 and a decorative layer 120 applied onto the carrier. In an edge region the carrier 100 comprises a profile 130 which is formed of a decorative portion 131 and a functional portion 132. Herein, the decorative portion 131 can consist of a chamfer of the edge, which in combination with a chamfer of a second panel connected to the decorative panel can form a V-shaped decorative joint. The functional portion 132 of the profile can be formed of a groove and/or a tongue, by means of which panels can be connected to each other. The decorative panel 100 according to the invention, in contrast to the hitherto known panels, comprises a decorative layer 120 at least in the region of the decorative profile 131. A wearing and/or top layer 140 which also extends at least over the profile 131, can be applied onto the decorative layer 120.

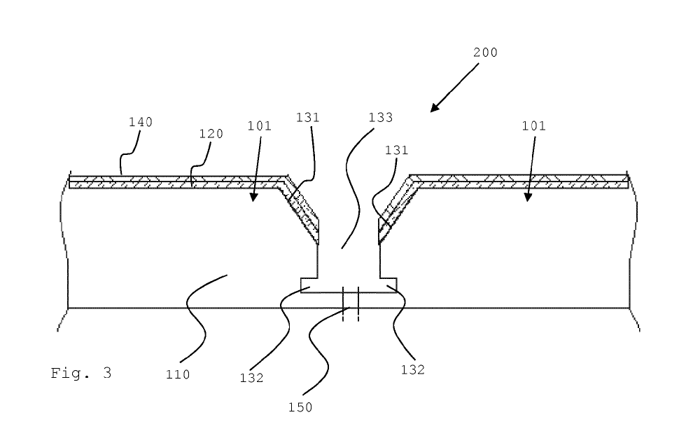

FIG. 2 shows a cross section of a profile 133 to be formed according to the present invention in a carrier 110 provided as a large plate 200. Here, the profile 133 has a Y-shape. Herein, the base width of the Y-shaped profile 133 is selected such that it comprises a bleed allowance 150 taking into account the cutting width occurring during the cutting of the large plate 200 into individual panels 101/102. The head of the Y-shaped profile 133 forms the chamfer 131 of the edges which is responsible for the eventual V-shaped decoration joint between panels connected to each other.

FIG. 3 shows a further configuration of a cross section of a profile 133 to be formed according to the present invention in a carrier 110 provided as a large plate 200. Herein, the profile 133 has a Y-shape with an extension in the base area. Herein, the base width of the Y-shaped profile 133 is selected such that in addition to a bleed allowance 150 it also comprises a functional profile 132 which, for example, forms a groove provided at an edge of the decorative panel 101/102. The head of the Y-shaped profile 133 forms the chamfer 131 of the edges which is responsible for the eventual V-shaped decoration joint between panels connected to each other.

1. Decorative panel comprising a plate-shaped carrier and a decorative layer applied onto the carrier, wherein the carrier has a profile at least in an edge region, characterized in that the decorative layer is applied even in the region of the profile.

2. Decorative panel according to claim 1, wherein the decorative layer replicates a natural material.

3. Decorative panel according to claim 1, wherein the plate-shaped carrier is formed of a material which is selected from the group consisting of wood, wood-based material, fiber material, plastic, glass, stone, ceramic, mineral material or mixtures thereof.

4. Decorative panel according to claim 1, wherein the decorative layer can be applied onto the carrier by of a printing technique.

5. Decorative panel according to claim 4, wherein the decorative layer can be applied by digital printing and/or screen printing.

6. Decorative panel according to claim 1, comprising a wearing and/or top layer applied onto the decorative layer.

7. Decorative panel according to claim 6, wherein the wearing and/or top layer comprises a surface texture substantially matching with the decor of the decorative layer.

8. Method for producing a decorative panel, including the steps of:
providing a plate-shaped carrier;
at least partially profiling the plate-shaped carrier; and
applying a decorative layer onto the at least partially profiled carrier.

9. Method according to claim 8, including the additional step of:
applying a wearing and/or top layer onto the decorative layer.

10. Method according to claim 9, including the additional step of:
forming a texture in the wearing and/or top layer, wherein the texture substantially matches with the decor of the decorative layer.

11. Method according to claim 8, wherein the plate-shaped carrier is provided as a large plate which is cut in a subsequent step into a plurality of decorative panels.

12. Method according to claim 11, wherein an additional profiling step is carried out at least in a partial region of the edges of the decorative panel substantially parallel to the surface of the panel.

13. Method according to claim 8, wherein the master used in the printing process is distortion corrected in the region of the profiles.

14. Method according to claim 13, wherein the correction of the distortion is implemented by adjusting the pixel spacing, the pixel size and/or the ink application depending on the intended edge profile of the finished decorative panel.

15. The decorative panel of claim 1 further comprising a wearing layer; wherein:
the decorative layer replicates a natural material and is a digital printed or screen printed layer directly on the carrier;
the wearing layer is directly on the decorative layer and has a haptically perceptual texture which corresponds with a decor of the decorative layer;
the profile consists of a functional portion and a decorative portion, and the decorative portion is an edge; and
the decorative layer on the carrier extends to the decorative portion of the profile.

16. The decorative panel of claim 15 wherein the decorative portion of the profile is a chamfer adapted to form a V-shaped decorative joint with a chamfer of a second decorative panel.

17. The decorative panel of claim 15 wherein the decorative layer on the carrier does not extend to the functional portion of the profile.

18. The decorative panel of claim 16 wherein the decorative layer on the carrier does not extend to the functional portion of the carrier.
